(19) United States
(12) Patent Application Publication
(10) Pub. No.: US 2021/0339480 A1
(43) Pub. Date: Nov. 4, 2021

(54) Support and Infill Materials and Processes for the Production of a Three-Dimensional Object

(71) Applicant: Alan Jeffrey Jacobs, Greenwood Village, CO (US)

(72) Inventors: Alan Jeffrey Jacobs, Greenwood Village, CO (US); Ian Daniel Jacobs, Greenwood Village, CO (US)

(73) Assignee: Alan Jacobs, Greenwood Village (CO)

(21) Appl. No.: 17/259,707

(22) PCT Filed: Jul. 16, 2019
(86) PCT No.: PCT/US2019/042057

§ 371 Date: Jan. 12, 2021

Related U.S. Application Data
(60) Provisional application No. 62/699,276, filed on Jul. 17, 2018.

(51) Int. Cl. B29C 64/40; B29C 64/264; B29C 64/118; B33Y 10/00; B33Y 30/00; B33Y 50/02; B29C 64/214; B29C 64/218; B29C 64/35; B33Y 40/00

(52) U.S. Cl. CPC B29C 64/40; B29C 64/264; B29C 64/118; B33Y 10/00; B33Y 30/00; B29K 2995/0059; B29C 64/214; B29C 64/218; B29C 64/35; B33Y 40/00; B33Y 50/02

(57) ABSTRACT

A system and process for manufacturing a three-dimensional object wherein a liquid material is deposited within boundary walls under overhanging regions of the object, the surface of which is triggered to polymerize by a polymerizing agent. The formation of the object being supported by the polymerized material contained within the boundary wall. A manufacturing system and process for a three-dimensional object wherein a cavity inside walls is filled with a liquid material that is polymerized to form a solid or semisolid infill

### BACKGROUND

Fused Deposition Modeling (FDM) or Fused Filament Fabrications (FFF) is an additive manufacturing process whereby and object is built by selectively depositing material in defined locations in a layer-by-layer process upwards from a build surface. A head attached to a 3-axis system extrudes melted material that solidifies when cooled. Support structures are required for building objects with overhangs as the melted material must be connected to previously extruded material on that layer or on a previous layer otherwise the extruded molten material will fall, sag or stick to the extruder head. Building a scaffolding of support structure is time consuming, utilizes excess material, and requires a time consuming manual process to subsequently remove the support material from the object. Common types of support patterns include zig-zag, grid, and concentric. Regions of the printed object that are in contact with the support material have lower dimensional accuracy than regions not in contact with support material. FDM objects are often built with a solid exterior shell and an interior infill region that is deposited at a lower density to save material and time. Common types of infill patterns include hexagonal and rectilinear. When building larger and more complex objects with taller overhangs, the time spent building the support structure can double, triple or more the overall time required to build the object. Thus, it is beneficial to develop a system capable of rapidly depositing support and/or infill material while building an object.

### SUMMARY

An FDM manufacturing process wherein the support material consists of a plurality of boundary walls under overhanging regions of an object such that before a layer of the overhang region is to be deposited, the volume contained within the boundary wall is filled with a liquid material, the surface of which is then triggered to polymerize by a polymerizing agent such as ultraviolet light or chemical additive. The extrusion of the subsequent overhanging layer of the object is then supported by the polymerized material contained within the boundary wall. Similarly, an FDM manufacturing process wherein the space between exterior shell walls is filled with a liquid material that is polymerized layer-by-layer to form a solid or semisolid infill.

### BRIEF DESCRIPTION OF THE DRAWINGS

FIG. 1 shows an apparatus with structural material extruder, a nozzle that dispenses liquid support resin and a light source that photopolymerizes the liquid support resin.

FIG. 2 shows an FDM object with an overhang region supported by boundary walls filled with liquid support material and a polymerized support layer.

FIG. 3 shows an FDM object with overhang boundary walls and a nozzle to dispense liquid support material positioned over the interior of the boundary walls.

FIG. 4 shows an FDM object with overhang boundary walls filled with liquid support material, a light source positioned over the liquid volume to polymerize the layer of liquid exposed to the light source.

FIG. 5 shows an FDM object with an overhang region supported by boundary walls and floor filled with liquid support material, a polymerized support layer, and FDM support layers on the polymerized support layer.

FIG. 6 shows an FDM object with an overhang region supported by boundary walls filled with interlaced regions of liquid support material, polymerized support material and FDM support.

FIG. 7 shows an FDM object exterior shell walls filled with liquid resin and polymerized layer-by-layer to form an infill.

FIG. 8. Shows a system for forming the three-dimensional structures with a controller coupled to motors for positioning a printing surface, motors for positioning and controlling material dispensers, motors and pumps for positioning and dispensing liquids, motors for controlling covers, light sources, and heaters and temperature sensors for controlling component and environmental temperatures.

### DETAILED DESCRIPTION

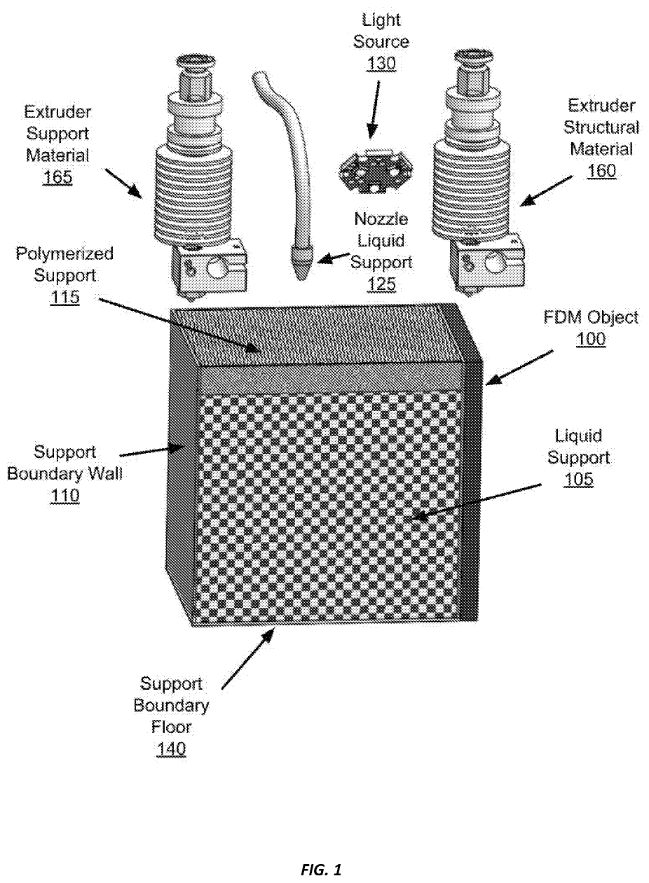

FIG. 1 illustrates apparatus in accordance with the embodiment of the invention. A structural material extruder 160 attached to a 3-axis system that delivers structural material at a controlled rate, a support material extruder 165 attached to a 3-axis system that delivers support material at a controlled rate, a liquid support nozzle 125 attached to a 3-axis system that delivers a liquid support resin 105 at a controlled rate, and a light source 130 that photopolymerizes the liquid support resin.

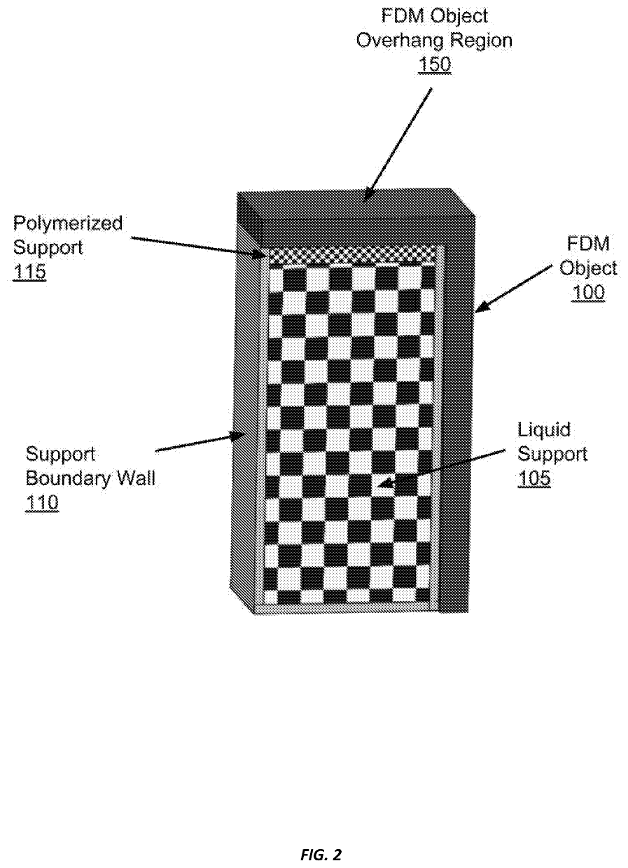

FIG. 2 illustrates a 3-dimensional object 100 containing an overhang region 150 built by the apparatus where the overhang region 150 is supported by a layer of polymerized support resin 115.

The formation of a 3-dimensional object 100 begins at the base layer and proceeds layer-by-layer with the deposition of structural material from structural material extruder 160 in the shape of the object. As the object 100 is formed layer-by-layer, bounding walls 110 of support material are deposited by the support material extruder 165 below regions of the object where subsequent layers will overhang previous layers 150.

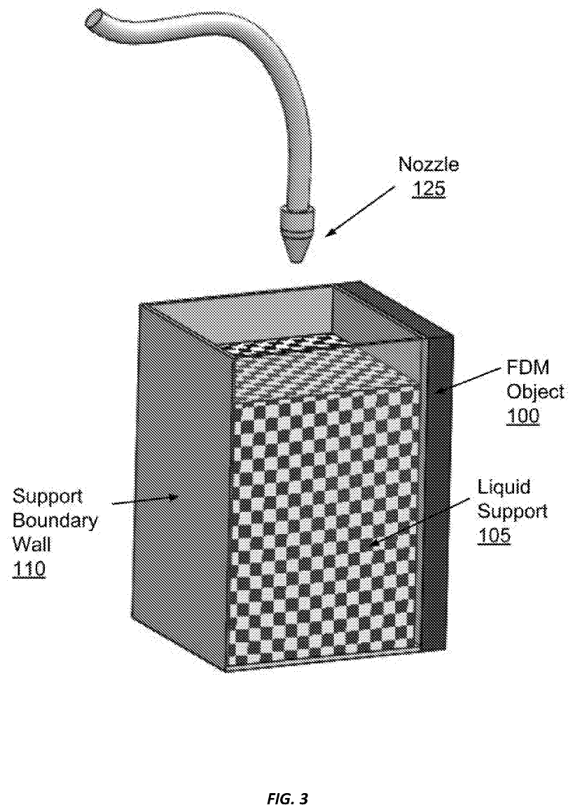

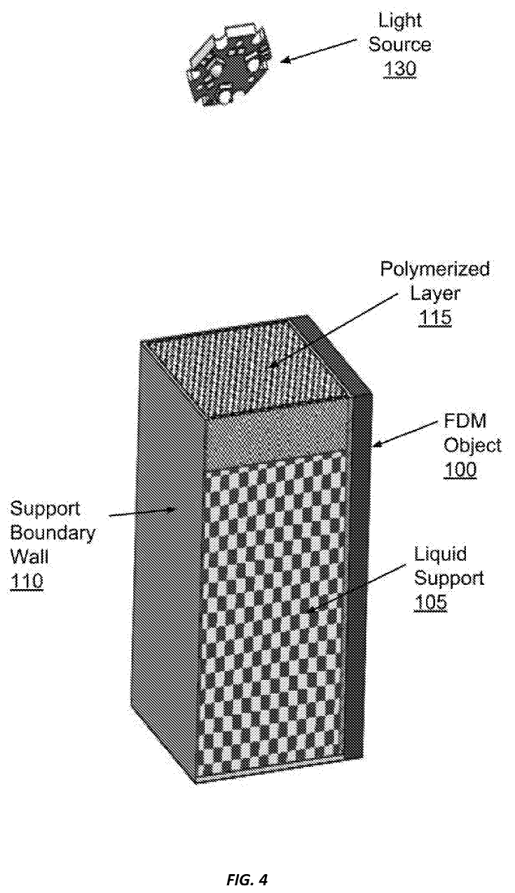

FIG. 3 illustrates prior to the deposition of material that overhangs a previous layer, the volume within the bounding walls 110 below the overhang are filled with a liquid resin 105, and FIG. 4 illustrates the upper most layer of the liquid resin polymerized to form a solid surface 115. After the upper most layer is solidified, the subsequent overhanging layers 150 of the object are deposited by the structural material extruder.

In one embodiment, the support resin 105 is a liquid state chemical that is induced to change to a solid or semi-solid state by irradiation with ultraviolet light, electron beams, x-rays, gamma rays, visible or invisible light, or reacted with other chemicals. Examples of UV curable chemicals are resins currently used in stereolithography additive manufacturing, adhesives and surface coatings. In another embodiment the liquid resin is polymerized to a semi-solid support material. In another embodiment, the liquid support material deposited inside the bounding walls is a mixture of a liquid and a solid material, a mixture of a liquid and a semi-solid material, or a foam. The admixed solid or semisolid materials could be selected to enhance the binding to subsequent layers to form temporary or permanent bonds to structural material or support material.

In one embodiment, the polymerized support resin 115 is dissolvable in aqueous, organic or inorganic solvents to facilitate removal of the support material without altering the structural material of the object. In another embodiment the unpolymerized support resin is dissolvable in aqueous, organic or inorganic solvents to facilitate removal of the support resin without altering the structural material of the object.

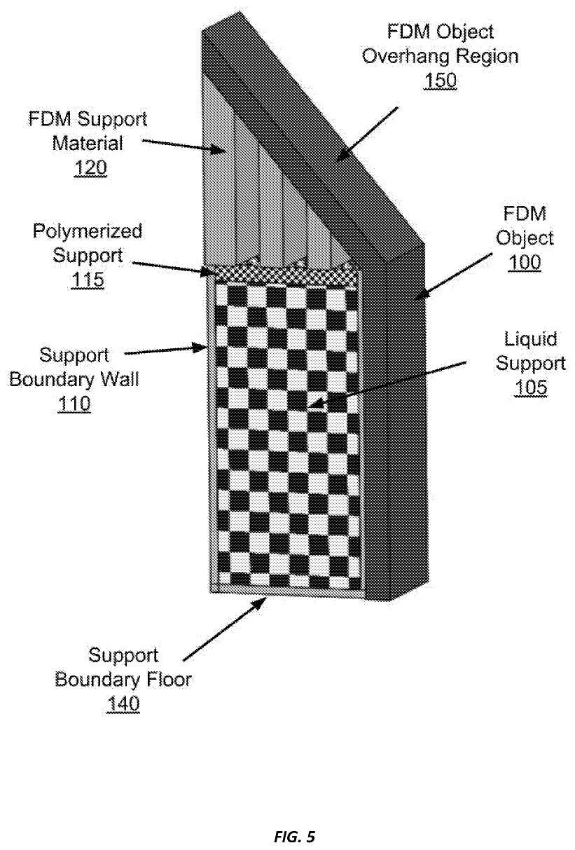

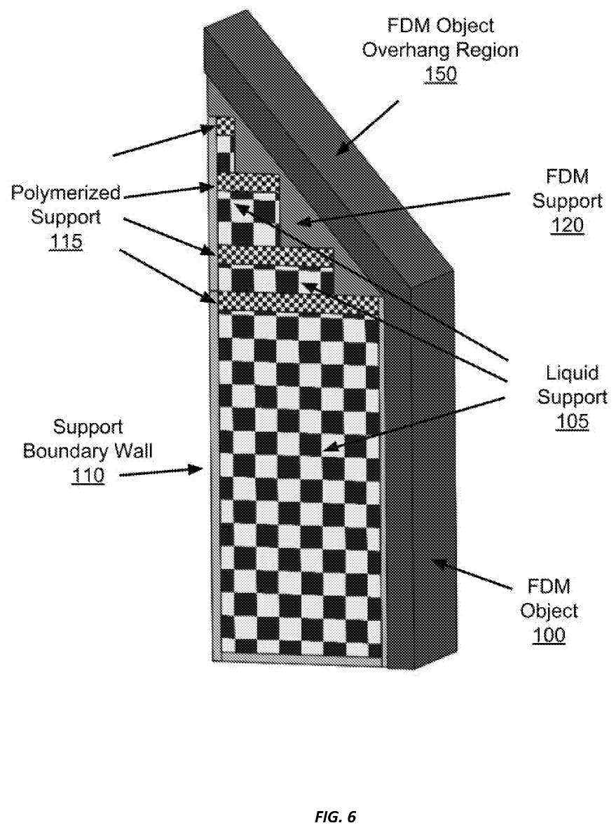

FIG. 5 illustrates a pattern of support material 120 layered on the polymerized resin as an interface between the polymerized resin 115 and the structural material of in the overhang region of the object 150. FIG. 6 illustrates another embodiment wherein the overhang region 150 is supported by boundary walls filled with interlaced regions of liquid support material 105, polymerized support material 115 and FDM support material 120.

In one embodiment the object is built in a temperature-controlled chamber, the temperature of which accelerates the transition of the resin from a liquid state to a solid state, and to minimize warping and distortion of the object being built.

In one embodiment the support region contains a floor 140 to contain liquid resin and prevent leakage. In another embodiment the bounding walls are surrounded by another set of walls to create a containment area to hold excess or overflowing liquid support material.

In one embodiment, after dispensing the liquid resin, the nozzle that dispensed the liquid resin is shielded from, or moved away from, the irradiation or chemicals that initiate polymerization of the resin. Shielding of the nozzle prevents liquid resin in the nozzle from being polymerized and obstructing the nozzle.

In one embodiment a plurality of nozzles dispenses liquid resin into the volume of the bounding walls. In another embodiment a plurality of different nozzles are used to dispense chemicals that initiate polymerization of the liquid resin.

In one embodiment, the support wall boundary and the polymerized support regions are configured to facilitate retrieval and reuse of the unpolymerized liquid support material. Access ports, guide routes, pressure relief ports can be built into the extruded support structure and the polymerized liquid support to direct unpolymerized resin to a collection vessel.

In one embodiment the extruded support material is the same material as the extruded structural material. In another embodiment the extruded support material and the extruded structural material are extruded by the same extruder.

In one embodiment, support material 120 is extruded by a plurality of extruders separate from the extruder delivering structural material.

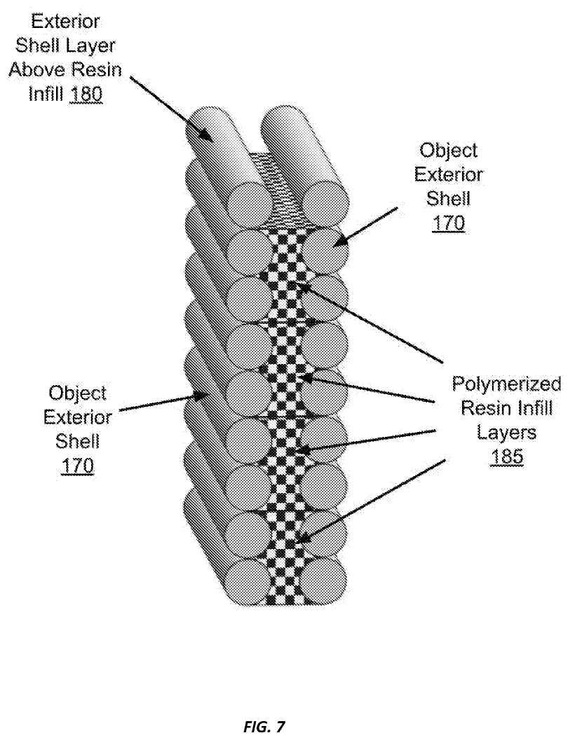

FIG. 7 shows another embodiment in which liquid resin is deposited layer-by-layer between the extruded exterior shell walls 170 of an object and polymerized to form a solid or semi-solid infill 185. Liquid infill is deposited to a depth less than or equal to the depth of the polymerization. Liquid infill can be deposited up to the level of the uppermost exterior shell wall layer, or to a level lower than the uppermost exterior shell layer 180.

In another embodiment the material deposited into the volume within the bounding walls 110 below the overhang is filled with a solid material or a semi-solid material. Examples of solid fill materials include particles, pellets, ball bearings, power, and granules.

When the fill material deposited inside the bounding walls is a solid or semisolid, a pellet for example, the pellets would be distributed evenly within the volume encompassed by the support bounding wall. Excess fill material protruding above the top layer of the bounding wall would flow over into a catch basin surrounding the bounding wall, or would be physically removed. Physical removal of the excess pellets could be performed by a blade, similar to that of a windshield wiper, to wipe off the excess pellets into a catch basin. Alternatively, a roller with a sticky surface would pass over the region to pick up the excess pellets. Alternatively, a roller whose outer surface is rotating in the same or opposite direction of its translation can be used to smooth the uppermost layer of support material, moving particles from regions above the top layer of the bounding wall to regions below the top layer, or moving excess material outside of the bounding walls. Alternatively, an adhesive plate could be lowered from above, and any pellets protruding above the top layer of the bounding wall would stick to the adhesive plate, removed from the interior of the bounding walls and deposited elsewhere. Alternatively an electrostatically charged plate could be used to attract and remove excess pellets. Pellets removed from the interior of the support bounding walls could be deposited into a reservoir for subsequent reuse.

Alternatively, the fill material could be a ferromagnetic or paramagnetic material, a steel ball bearing for example. In this case a permanent or electromagnet would be used to pick up magnetically attracted excess ball bearings and removed them from the interior of the bounding walls to be deposited elsewhere.

In another embodiment, the fill material is a liquid expandable foam placed inside the support bounding walls. When the support material comes in contact with air, a lower pressure environment, is chemically activated or photo activated, it begins to expand. A plate would then be lowered from above, sealing the top of surface the support bounding walls, containing the expanding foam as it fills the volume inside the bounding walls.

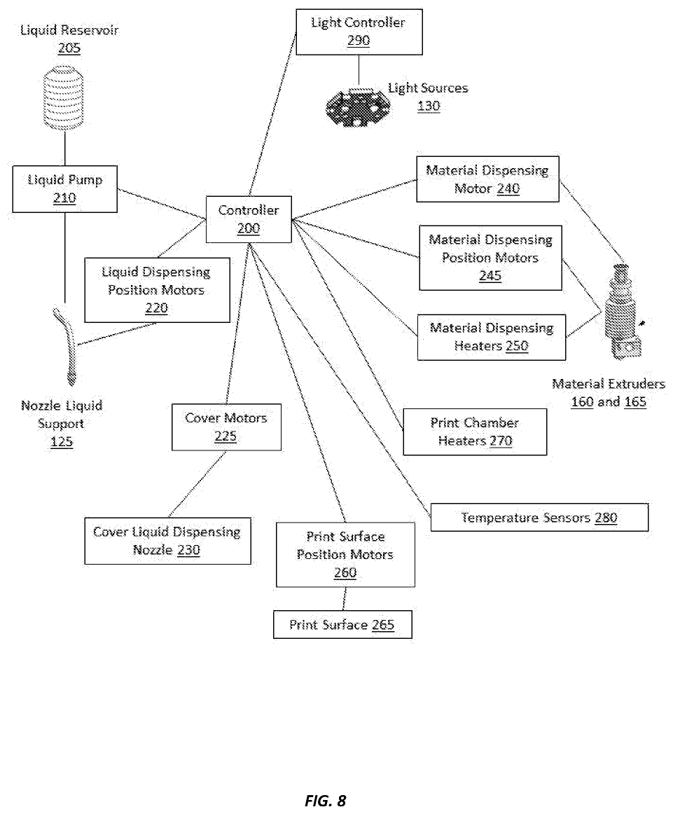

FIG. 8 shows the system for forming the three-dimensional structures with a controller 200 coupled to (A) motors 260 for positioning a printing surface 265, (B) motors 245 for positioning material extruders 160 and 165, (C) motors for dispensing material 240, (D) heaters for material dispensing 250, (E) print chamber heaters 270, (F) temperature sensors 280, (G) light controller 290 coupled to light sources 130, (H) Liquid pump 210 for moving liquid from the liquid tank 205 to the nozzle 125, (I) motors 220 for positioning a liquid dispensing nozzle 125, (J) motors 225 for positioning a cover 230 over the liquid dispensing nozzle 125.

What is claimed is:

1. A method for forming a three-dimensional structure, the method comprising:
forming a first portion of an object to be created by the system by depositing a material in a plurality of overlapping layers;
forming a cavity adjacent to the portion of the object;
filling the cavity with a liquid material;
causing the liquid material to polymerize by applying a polymerizing agent; and
forming a second portion of the object over the polymerized liquid material, the second portion of the object connected to the first portion.

2. The method of claim 1, wherein the liquid material is a mixture of a liquid and a solid material, a mixture of a liquid and a semi-solid material, or a foam.

3. The method of claim 1, wherein the liquid material is selected to enhance the binding to a portion of the object to form temporary or permanent bonds.

4. The method of claim 1, wherein the liquid material is caused to polymerize by irradiation with ultraviolet light, electron beams, x-rays, gamma rays, visible or invisible light, or reacted with other chemicals.

5. The method of claim 1, wherein heat is applied to facilitate the polymerization of the liquid material.

6. The method of claim 1, wherein only a portion of the liquid material is polymerized.

7. The method of claim 1, further comprising subsequently removing a portion of the polymerized or unpolymerized liquid material from the formed object.

8. The method of claim 1, wherein the polymerized liquid material is dissolvable in aqueous, organic or inorganic solvents to facilitate removal.

9. The method of claim 1, wherein the liquid material is deposited layer-by-layer, and each layer is polymerized to form a solid or semi-solid material.

10. The method of claim 1, wherein the liquid material is deposited to a depth less than or equal to a depth of the polymerization.

11. The method of claim 1, wherein liquid material is deposited up to a level of the uppermost layer of a portion of the object.

12. The method of claim 1, wherein after dispensing the liquid material, the nozzle that dispensed the liquid is shielded from, or moved away from, the irradiation or chemicals that initiate polymerization of the liquid.

13. The method of claim 1, wherein at least one of bounding walls and a floor are deposited adjacent to a portion of the object to form the cavity.

14. The method of claim 1, wherein the cavity is surrounded by a set of walls to create a containment area to hold excess or overflowing material from the cavity.

15. The method of claim 1, wherein the at least one of the cavity and a portion of the object is configured to facilitate retrieval and reuse of the liquid, solid or semisolid material from the cavity.

16. The method of claim 1, further comprising: collecting excess material flowing from the cavity over a top layer of the cavity into a catch basin surrounding the cavity.

17. The method of claim 1, wherein access ports, guide routes, or pressure relief ports are built into the cavity, a portion of the object, or a support for the polymerized liquid to direct material in the cavity to a collection vessel.

18. The methods of claim 1, further comprising: subsequently removing from the cavity a portion of the liquid, solid or semisolid material.

19. The method of claim 1, wherein a plurality of materials are deposited on the polymerized liquid material, semisolid material, or solid material as an interface between the polymerized liquid material and a portion of the object.

20. The method of claim 19, wherein the materials deposited on the polymerized liquid material, semisolid material, or semisolid material, as an interface between the polymerized liquid material and a portion of the object, are separable from the object.

21. The method of claim 1, wherein the cavity contains interlaced regions of object material, liquid material, polymerized liquid material, semisolid material or solid material.

22. A method for forming three-dimensional structures, the method comprising:
forming a first portion of an object to be created by the system by depositing a material in a plurality of overlapping layers;
forming a cavity adjacent to the portion of the object;
filling the cavity with a solid or semisolid material; and
forming a second portion of the object over the solid or semisolid material, the second portion of the object connected to the first portion.

23. The method of claim 22, wherein the solid or semisolid material comprises particles, pellets, ball bearings, power, or granules.

24. The method of claim 22, further comprising: removing excess material from the cavity.

25. The method of claim 24, wherein removal of excess material is performed by a blade to wipe off material into a catch basin.

26. The method of claim 24, wherein removal of the excess material is performed by a roller whose outer surface is rotating in the same or opposite direction of its translation.

27. The method of claim 24 wherein removal of the excess material is performed by an adhesive surface, electrostatically charged plate, electromagnet or permanent magnet.

28. The method of claim 24, wherein the excess material removed is deposited into a reservoir for subsequent reuse.

29. The method of claim 22, wherein the cavity is formed by one or more bounding walls and/or a floor deposited adjacent to a portion of the object.

30. The method of claim 29, wherein the bounding walls are surrounded by another set of walls to create a containment area to hold excess or overflowing material from the cavity.

31. The method of claim 29, wherein the bounding walls and/or a portion of the object are configured to facilitate retrieval and reuse of the liquid, solid or semisolid material from the cavity.

32. The method of claim 22, further comprising: collecting excess material flowing from the cavity over a top layer of the cavity into a catch basin surrounding the cavity.

33. The method of claim 29, wherein access ports, guide routes, or pressure relief ports are built into the bounding walls, a portion of the object, or a support for the polymerized liquid to direct material in the cavity to a collection vessel.

34. The method of claim 22, further comprising: subsequently removing from the cavity a portion of the liquid, solid, or semisolid material.

35. The method of claim 22, wherein a plurality of materials are deposited on the polymerized liquid material, semisolid material, or solid material as an interface between the polymerized liquid material and a portion of the object.

36. The method of 35, wherein the materials deposited on the polymerized liquid material, semisolid material, or semisolid material, as an interface between the polymerized liquid material and a portion of the object, are separable from the object.

37. The method of claim 22, wherein the cavity contains interlaced regions of object material, liquid material, polymerized liquid material, semisolid material or solid material.

38. A method for forming three-dimensional structures, the method comprising:
forming a first portion of an object to be created by the system by depositing a material in a plurality of overlapping layers;
forming an internal cavity in a portion of the object;
filling the cavity with a liquid material;
causing the liquid material to polymerize by applying a polymerizing agent.

39. A method for forming three-dimensional structures, the method comprising:
forming a first portion of an object to be created by the system by depositing a structural material in a plurality of overlapping layers;
forming an internal cavity in a portion of the object;
filling the cavity with a semisolid or solid material;

40. A system for forming three-dimensional structures, the system comprising:
a controller;
a printing surface;
a dispenser coupled to the controller, the controller configured to cause the dispenser to form a first portion of an object by depositing a first material in a plurality of overlapping layers onto the printing surface;
a reservoir for holding a liquid material;
a liquid dispenser coupled to the controller, the controller configured to cause the liquid dispenser to deposit the liquid material therefrom to a cavity formed by the first material; and
a light source coupled to the controller, the controller configured to cause the light to polymerize the liquid material in a cavity within the printing surface;
wherein the controller is further configured to cause the dispenser to form a second portion of the object over the polymerized liquid material, the second portion of the object connected to the first portion.

41. The system of claim 40, wherein a heater and temperature sensors are coupled to the controller, and the controller is configured to maintain the temperature around the object within a selected temperature range.

42. The system of claim 41, wherein the selected temperature range is selected to facilitate the transition of the liquid material into a solid or semisolid state.

43. The system of claim 40, wherein a cover is coupled to a motor, the motor is coupled to the controller, and the controller is configured to cover the liquid dispenser when the light source is turned on.

44. A system for forming three-dimensional structures, the system comprising:
a controller;
a printing surface;
a first dispenser coupled to the controller, the controller configured to cause the first dispenser to form a first portion of an object by depositing a first material in a plurality of overlapping layers onto the printing surface;
a first reservoir for holding a liquid or semisolid material;
a second dispenser coupled to the controller, the controller configured to cause the second dispenser to deposit the liquid or semisolid material from the first reservoir to a cavity formed by the first material; and
a second reservoir for holding an activator material;
a third dispenser coupled to the controller, the controller configured to cause the third dispenser to deposit the activator material from the second reservoir to a cavity formed by the first material; and
wherein the controller is further configured to cause the dispenser to form a second portion of the object over the polymerized liquid or semisolid material, the second portion of the object connected to the first portion.

45. The system of claim 44, wherein a heater and temperature sensors are coupled to the controller, and the controller is configured to maintain the temperature around the object within a selected temperature range.

46. The system of claim 45, wherein the selected temperature range is selected to facilitate the transition of the liquid material into a solid or semisolid state.

47. The system of claim 44, wherein a cover is coupled to a motor, the motor is coupled to the controller, and the controller is configured to cover the second dispenser when the activator material is dispensed.
